(19) United States
(12) Patent Application Publication
(10) Pub. No.: US 2002/0138790 A1
(43) Pub. Date: Sep. 26, 2002

(54) Apparatus and method for managing errors on a point-to-point interconnect

(76) Inventor: Satyanarayana Nishtala, Cupertino, CA (US)

Correspondence Address: PARK, VAUGHAN & FLEMING LLP, 508 SECOND STREET, SUITE 201, DAVIS, CA, 95616, US

(21) Appl. No.: 09/818,025

(22) Filed: Mar. 26, 2001

(51) Int. Cl. G06F 11/26

(52) U.S. Cl. 714/43

(57) ABSTRACT

One embodiment of the present invention provides a system for facilitating error management on a point-to-point interconnect within a system. The system includes the point-to-point interconnect, a source of data transactions coupled to the point-to-point interconnect, and a destination of data transactions coupled to the point-to-point interconnect. A transmitting mechanism at the source transmits data transactions to the destination across the point-to-point interconnect. A receiving mechanism at the destination receives these data transactions from the point-to-point interconnect. The apparatus also includes a synchronizing mechanism that is configured to synchronize the source and destination. A local buffer at the source stores a copy of each data transaction that is transmitted from the source. A detecting mechanism at the destination is used to detect failed data transactions using any method useful for detecting failed data transactions, for example, parity, cyclic redundancy code, error correcting code, and the like

### BACKGROUND

1. Field of the Invention

The present invention relates to managing errors in communications between functional units in a system. More specifically, the present invention relates to an apparatus and a method for managing errors on a point-to-point interconnect within a system.

2. Related Art

It is essential for the various functional units of a computing system to communicate with each other in order for the computing system to perform its assigned tasks. Traditionally, these functional units, which include the central processing unit, memory, I/O devices, and the like, are coupled together by a bus structure. When a first functional unit needs to communicate with a second functional unit, the first functional unit typically requests access to the bus from a bus master. The bus master then grants the first functional unit exclusive access to the bus for a bus transaction. During the transaction, the bus is not available to the other functional units.

The bus approach was acceptable for older, slower computing systems. However, modem computing systems operate at much higher clock frequencies. These higher clock frequencies cause the bus structure to become a bottleneck for data transactions.

In an effort to alleviate this bottleneck, designers have implemented point-to-point interconnects among the functional units within a computing system. These point-to-point interconnects couple the source of a data transaction with the destination of the data transaction.

Even though the point-to-point interconnects alleviate the bottleneck associated with a bus structure, it can be challenging to preserve the transaction ordering. While maintaining the transaction ordering is trivial when no errors are present, transactions with errors have to be handled with care to preserve ordering semantics of transactions.

One approach to handling transactions with errors is to have the destination of the transaction respond to each transaction with an acknowledge message or a negative acknowledge message, depending upon the state of the received transaction. If the destination responds with a negative acknowledgement message, the transmission is retried.

While this method is able to preserve the order of the transactions, this method severely limits throughput on the point-to-point interconnect because the source must wait for the acknowledgement before starting another transaction. If the source initiates other transactions prior to receiving the acknowledgement, determining which transactions fail is difficult. In addition, resending a transaction could cause the transactions to be executed out of order at the destination.

What is needed is an apparatus and a method that allows a point-to-point interconnect to be used efficiently, while correcting transmission errors and maintaining the transaction-ordering model.

### SUMMARY

One embodiment of the present invention provides a system for facilitating error management on a point-to-point interconnect within a system. The system includes the point-to-point interconnect, a source of data transactions coupled to the point-to-point interconnect, and a destination of data transactions coupled to the point-to-point interconnect. A transmitting mechanism at the source transmits data transactions to the destination across the point-to-point interconnect. A receiving mechanism at the destination receives these data transactions from the point-to-point interconnect. The apparatus also includes a synchronizing mechanism that is configured to synchronize the source and destination. A local buffer at the source stores a copy of each data transaction that is transmitted from the source. A detecting mechanism at the destination is used to detect failed data transactions using any method useful for detecting failed data transactions, for example, parity, cyclic redundancy code, error correcting code, and the like.

In one embodiment of the present invention, the apparatus includes a transmit sequence number counter at the source, and a receive sequence number counter at the destination. The synchronizing mechanism sets the transmit sequence number counter and the receive sequence number counter to identical values.

In one embodiment of the present invention, the apparatus assigns a transmit sequence number from the transmit sequence number counter to each data transaction stored in the local buffer.

In one embodiment of the present invention, the apparatus assigns a receive sequence number from the receive sequence number counter to each data transaction received at the destination.

In one embodiment of the present invention, the apparatus includes a negative acknowledgement generating mechanism. This negative acknowledgement generating mechanism generates a negative acknowledgement when the detecting mechanism at the destination detects a failed data transaction. The negative acknowledgement includes the receive sequence number associated with the failed data transaction.

In one embodiment of the present invention, the destination sends the negative acknowledgement to the source.

In one embodiment of the present invention, the destination disregards subsequent data transactions after detecting the failed data transaction until a resynchronization sequence is received from the source.

In one embodiment of the present invention, the source receives the negative acknowledgement from the destination.

In one embodiment of the present invention, a resynchronizing mechanism resynchronizes the transmit sequence number counter at the source and the receive sequence number counter at the destination after receipt of the negative acknowledgement.

In one embodiment of the present invention, the source retransmits data transactions from the local buffer. Retransmission starts upon receipt of the negative acknowledgement and retransmitted data transactions start with the failed data transaction associated with the receive sequence number contained in the negative acknowledgement.

In one embodiment of the present invention, the local buffer is large enough to hold a data transaction until it is no longer possible to receive the negative acknowledgement for that data transaction.

In one embodiment of the present invention, the system ensures that data transactions are processed in order and no data transaction is processed more than once.

### BRIEF DESCRIPTION OF THE FIGURES

FIG. 1A illustrates computing elements coupled together in accordance with an embodiment of the present invention.

FIG. 1B illustrates details of synchronizing counters in accordance with an embodiment of the present invention.

FIG. 1C illustrates transmission and buffering of data transactions in accordance with an embodiment of the present invention.

FIG. 1D illustrates reception and error detection of data transactions in accordance with an embodiment of the present invention.

FIG. 1E illustrates generation and reception of a negative acknowledgement message in accordance with an embodiment of the present invention.

FIG. 2A illustrates empty data transaction buffer 118 in accordance with an embodiment of the present invention.

FIG. 2B illustrates data transaction buffer 118 with a single entry in accordance with an embodiment of the present invention.

FIG. 2C illustrates data transaction buffer 118 with multiple entries in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Computing Elements

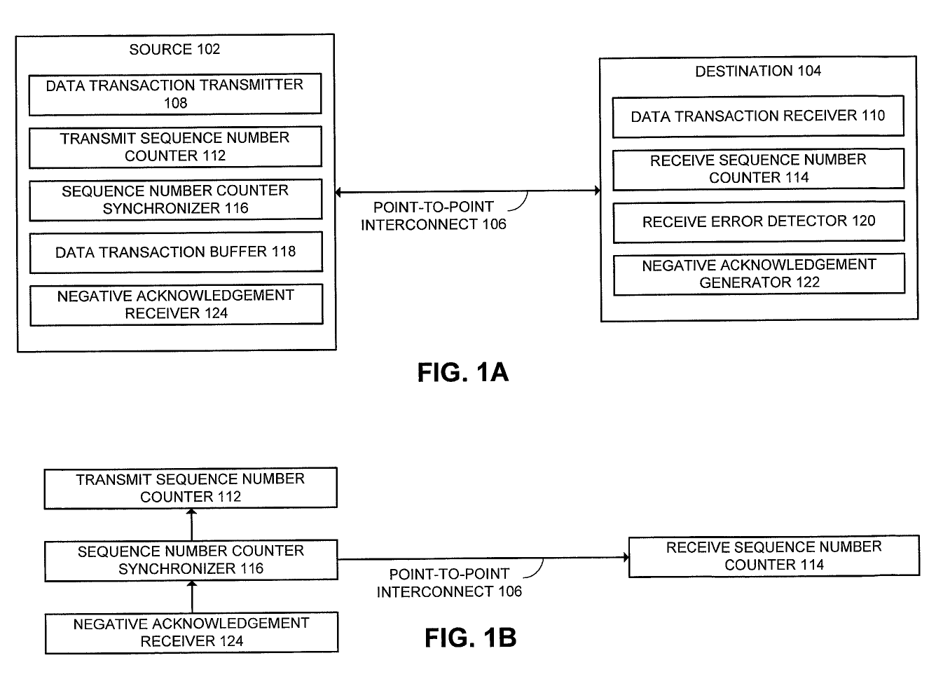

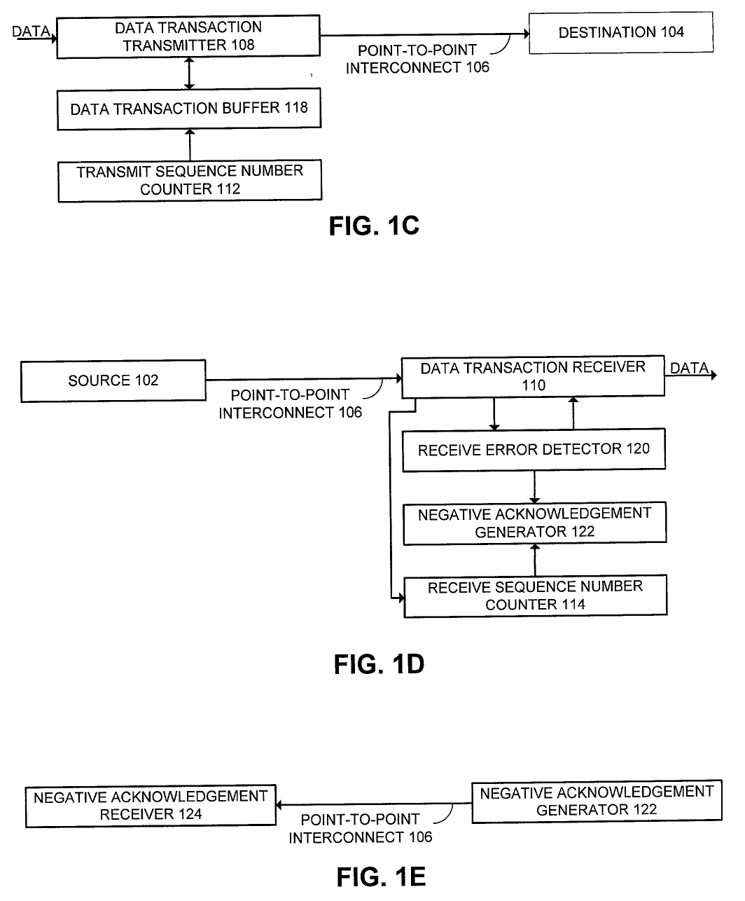

FIG. 1A illustrates computing elements coupled together in accordance with an embodiment of the present invention. Source 102 and destination 104 are coupled together by point-to-point interconnect 106. Source 102 can include any source of data transactions within a computing system. For example, source 102 can include a central processing unit. Destination 104 can include any destination of data transactions within a computing system. For example, destination 104 can include an input/output subsystem.

Source 102 includes data transaction transmitter 108, transmit sequence number counter 112, sequence number counter synchronizer 116, data transaction buffer 118, and negative acknowledgement receiver 124. The operation of each of these elements will be discussed in detail below.

Destination 104 includes data transaction receiver 110, receive sequence number counter 114, receive error detector 120, and negative acknowledgement generator 122. The operation of each of these elements will also be discussed in detail below.

FIG. 1B illustrates details of synchronizing counters in accordance with an embodiment of the present invention. When the system is started, sequence number counter synchronizer 116 sets transmit sequence number counter 112 to an initial value, say zero. Sequence number counter synchronizer 116 also sends a synchronize sequence to receive sequence number counter 114 across point-to-point interconnect 106 to set receive sequence number counter 114. This causes receive sequence number counter 114 to be set to the same value as transmit sequence number counter 112.

During operation, if a negative acknowledgement is received by negative acknowledgement receiver 124, sequence number counter synchronizer 116 sets transmit sequence number counter 112 to the value of the failed data transaction received in the negative acknowledge.

FIG. 1C illustrates transmission and buffering of data transactions in accordance with an embodiment of the present invention. When source 102 has a data transaction to send to destination 104, data transaction transmitter 108 sends the data transaction to destination 104 across point-to-point interconnect 106. Note that there may be several data transactions in process at any given time.

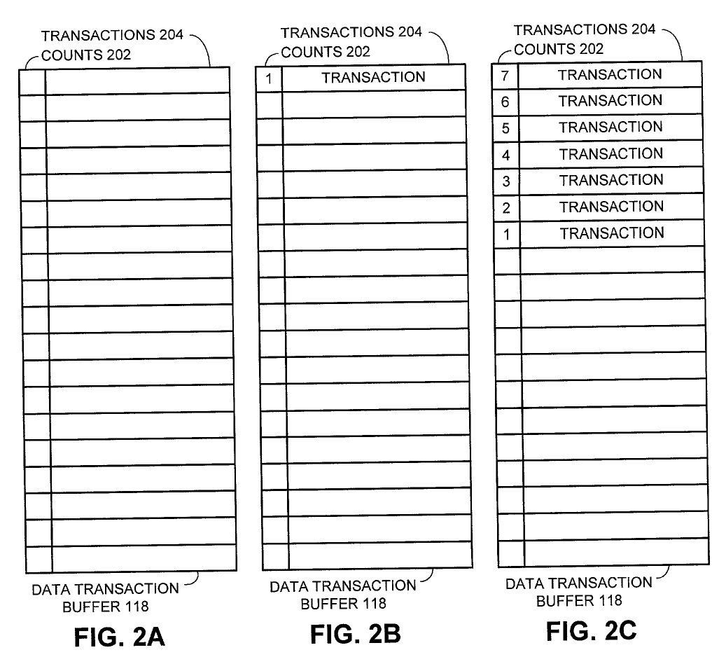

Simultaneously, data transaction transmitter 108 stores a copy of the data transaction in data transaction buffer 118. Transmit sequence number counter 112 is then incremented and the current value of transmit sequence number counter 112 is also stored in data transaction buffer 118. The operation of data transaction buffer 118 is discussed in more detail in conjunction of FIGS. 2A, 2B, and 2C below.

FIG. 1D illustrates reception and error detection of data transactions in accordance with an embodiment of the present invention. When source 102 sends a data transaction across point-to-point interconnect 106, data transaction receiver 110 receives the data transaction. Data transaction receiver then sends a signal to receive sequence number counter 114 which increments receive sequence number counter 114. Note that the receive sequence number associated with the data transaction is the same as the transmit sequence number associated with the data transaction. There will be, however, a time skew between when transmit sequence number counter 112 is incremented and when receive sequence number counter 114 is incremented.

When data transaction receiver 110 receives a data transaction, receive error detector 120 inspects the data transaction for errors. If an error is detected, receive error detector 120 signals data transaction receiver 110 to stop receiving data transactions until a resynchronize sequence is received from sequence number counter synchronizer 116. Note that any data transactions sent from source 102 during this time period will be ignored.

Negative acknowledgement generator 122 also receives the receive sequence number from receive sequence number counter 114 to include in the negative acknowledgement.

FIG. 1E illustrates generation and reception of a negative acknowledgement message in accordance with an embodiment of the present invention. Negative acknowledgement generator 122 sends the negative acknowledgement across point-to-point interconnect 106 to negative acknowledgement receiver 124.

Note that data transactions with no errors are not acknowledged. Since it is usual for there to be no error, this invention saves time by not acknowledging valid data transactions. However, data transaction buffer 118 must be large enough to hold a data transaction until it is no longer possible to receive a negative acknowledgement. Note that the number of transactions that can be outstanding at any given time can be determined from the number of data transactions that can be sent during the maximum round trip time between sending a data transaction and receiving a negative acknowledgement for the data transaction.

Data Transaction Buffer

FIG. 2A illustrates empty data transaction buffer 118 in accordance with an embodiment of the present invention. Data transaction buffer 118 may be any type of buffer suitable for holding data transactions. For example, data transaction buffer 118 may be a stack, a queue, or a circular buffer.

Data transaction buffer 118 includes two parts, counts 202 and transactions 204. Counts 202 holds the value from transmit sequence number counter 112 associated with a data transaction in transactions 204. Prior to source 102 sending a data transaction to destination 104, the buffer is empty as shown.

FIG. 2B illustrates data transaction buffer 118 with a single entry in accordance with an embodiment of the present invention. After the first data transaction is sent from source 102 to destination 104, the data transaction is stored in transactions 204 of data transaction buffer 118. Associated with the transaction is the value of transmit sequence number counter 112, in the example, the value is 1.

FIG. 2C illustrates data transaction buffer 118 with multiple entries in accordance with an embodiment of the present invention. As source 102 continues to generate data transactions, the data transactions are copied to transactions 204 within data transaction buffer 118. Each data transaction is associated with the current value of transmit sequence number counter 112 when the data transaction is sent. In the example, the first seven data transactions are shown in data transaction buffer 118.

If a negative acknowledgement is received by negative acknowledgement receiver 124, the receive sequence number within the negative acknowledgement is used to locate the failed data transaction. Remember that transmit sequence number counter 112 and receive sequence number counter 114 associate the same value with a given data transaction.

Once the failed data transaction is located within data transaction buffer 118, data transaction transmitter 108 retransmits the failed data transaction along with all subsequent data transactions in data transaction buffer 118. After retransmitting the data transactions from data transaction buffer 118, source 102 continues with any new data transactions. In this way, all data transactions are guaranteed to be in the correct order.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An apparatus for facilitating error management on a point-to-point interconnect within a system, the apparatus comprising:
the point-to-point interconnect;
a source of data transactions coupled to the point-to-point interconnect;
a destination of data transactions coupled to the point-to-point interconnect;
a transmitting mechanism at the source that is configured to transmit data transactions to the point-to-point interconnect;
a receiving mechanism at the destination that is configured to receive data transactions from the point-to-point interconnect;
a synchronizing mechanism that is configured to synchronize the source and destination;
a local buffer at the source that is configured to store a copy of each data transaction that is transmitted from the source; and
a detecting mechanism at the destination that is configured to detect a failed data transaction, wherein the detecting mechanism uses any method able to detect the failed data transaction.

2. The apparatus of claim 1, further comprising:
a transmit sequence number counter at the source; and
a receive sequence number counter at the destination, wherein the synchronizing mechanism is configured to set the transmit sequence number counter and the receive sequence number counter to identical values.

3. The apparatus of claim 2, further comprising a first assigning mechanism that is configured to assign a transmit sequence number from the transmit sequence number counter to each data transaction stored in the local buffer.

4. The apparatus of claim 3, further comprising a second assigning mechanism that is configured to assign a receive sequence number from the receive sequence number counter to each data transaction received at the destination.

5. The apparatus of claim 4, further comprising a negative acknowledgement generating mechanism that is configured to generate the negative acknowledgement when the detecting mechanism at the destination detects the failed data transaction, wherein the negative acknowledgement includes the receive sequence number for the failed data transaction.

6. The apparatus of claim 5, further comprising an error response mechanism that is configured to respond to the failed data transaction by sending the negative acknowledgement to the source.

7. The apparatus of claim 5, wherein the receiving mechanism is configured to disregard data transactions after detecting the failed data transaction until a resynchronization sequence is received from the source.

8. The apparatus of claim 6, further comprising a negative acknowledgement receiving mechanism at the source that is configured to receive the negative acknowledgement from the destination.

9. The apparatus of claim 8, further comprising a resynchronizing mechanism that is configured to resynchronize the transmit sequence number counter at the source and the receive sequence number counter at the destination upon receipt of the negative acknowledgement.

10. The apparatus of claim 8, further comprising a retransmitting mechanism at the source that is configured to retransmit data transactions from the local buffer, wherein data transactions are retransmitted starting with the failed data transaction associated with the receive sequence number contained in the negative acknowledgement.

11. The apparatus of claim 8, wherein the local buffer is large enough to hold a data transaction until it is no longer possible to receive the negative acknowledgement.

12. The apparatus of claim 10, wherein data transactions are processed in order and no data transaction is processed more than once.

13. A method for managing errors on a point-to-point interconnect within a system, the method comprising:
synchronizing a source of data transactions with a destination of data transactions;
transmitting a plurality of data transactions from the source to the destination;
saving a copy of each data transaction of the plurality of data transactions in a local buffer at the source; and
if a negative acknowledgement is received at the source for a failed data transaction in the plurality of data transactions,
resynchronizing the source and the destination, and
retransmitting the failed data transaction and all subsequent data transactions from the local buffer at the source to the destination.

14. The method of claim 13, further comprising:
setting a transmit sequence number counter at the source; and
setting a receive sequence number counter at the destination, wherein the transmit sequence number counter and the receive sequence number counter are set to identical values during synchronization.

15. The method of claim 14, further comprising assigning a transmit sequence number from the transmit sequence number counter to each data transaction stored in the local buffer.

16. The method of claim 15, further comprising assigning a receive sequence number from the receive sequence number counter to each data transaction received at the destination, wherein the receive sequence number and the transmit sequence number are identical for a given data transaction.

17. The method of claim 16, further comprising sending the receive sequence number with the negative acknowledgement from the source to the destination if an error is detected in the given data transaction at the destination.

18. The method of claim 17, further comprising deleting all data transactions received at the destination after the negative acknowledgement is sent and until a resynchronization is received.

19. The method of claim 13, wherein the local buffer contains sufficient data transactions so that the negative acknowledgement can be received for the failed data transaction prior to the failed data transaction being deleted from the local buffer.

20. A system for facilitating error management on a point-to-point interconnect, the system comprising:
a central processing unit, wherein the central processing unit is a source of data transactions;
an input/output unit, wherein the input/output unit is a destination of data transactions;
a point-to-point interconnect, wherein the point-to-point interconnect is coupled to both the central processing unit and the input/output unit;
a transmit sequence counter at the source;
a receive sequence counter at the destination;
a synchronizing mechanism that is configured to synchronize a transmit sequence number and a receive sequence number;
a local buffer at the source that is configured to store a copy of each data transaction that is transmitted from the source;
a detecting mechanism at the destination that is configured to detect a failed data transaction;
a sending mechanism at the destination that is configured to send a negative acknowledgement when the detecting mechanism detects the failed data transaction, wherein the negative acknowledgement includes the receive sequence number from the failed data transaction;
wherein received data transactions are disregarded after detecting the failed data transaction until a resynchronization sequence is received from the source;
a receiving mechanism at the source that is configured to receive the negative acknowledgement from the destination;
a resynchronizing mechanism that is configured to resynchronize the transmit sequence number and the receive sequence number in response to receiving the negative acknowledgement; and
a retransmitting mechanism at the source that is configured to retransmit data transactions from the local buffer starting with the failed data transaction.
